(19) United States
(12) Patent Application Publication
(10) Pub. No.: US 2016/0329712 A1
(43) Pub. Date: Nov. 10, 2016

(54) SYSTEM AND METHOD FOR OPTIMIZING ENERGY SUPPLIED FROM ENERGY SOURCES TO LOAD DEVICES

(71) Applicants: Shailesh Upreti, Ithaca, NY (US); Mike Freni, Rancho Palos Verdes, CA (US)

(72) Inventors: Shailesh Upreti, Ithaca, NY (US); Mike Freni, Rancho Palos Verdes, CA (US)

(21) Appl. No.: 14/824,068

(22) Filed: Aug. 11, 2015

Related U.S. Application Data
(60) Provisional application No. 62/036,093, filed on Aug. 11, 2014.

(51) Int. Cl. H02J 3/38; G05B 13/02; H02M 7/68

(52) U.S. Cl. CPC H02J 3/382; H02J 3/383; H02J 3/386; H02J 3/387; H02M 7/68; G05B 13/021; G05B 2219/25387

(57) ABSTRACT

A hybrid system for optimizing energy supplied from energy sources to load device is described. The hybrid system includes a memory, a power and energy module, and a processor coupled to the memory. The power and energy module determines power and energy needed by the load device. The processor executes instructions stored in the memory to receive information associated with the determined power and energy from the power and energy module, and optimizes the energy generated by the energy sources for supplying to the a load device by selecting at least one energy source of the energy sources based on the received information and selection priority of the energy sources.

### CROSS-REFERENCE TO RELATED APPLICATIONS

This application claims priority to U.S. Provisional Patent No. 62/036,093 filed Aug. 11, 2014.

### TECHNICAL FIELD

Embodiments of the present subject matter generally relate to optimization of energy supplied from energy sources to load devices, and more particularly, to optimization of energy supplied from energy sources to load devices based on energy need of the load devices.

### BACKGROUND

Current systems for optimization of energy utilize several types of sensors and computational units. Such computational units may improve gain and can be limited in managing energy because of excessive wastage and losses of the energy from energy sources. Some typical systems may receive energy from several types of energy sources. The received energy is then stored in storage units and later on the stored energy can be supplied to loads. However, such systems lose a significant amount of energy either during conversion, storage, or transfer of the energy. Also, some typical systems receive and process input relating to only a set of particular type of sensors. Such sensors exhibit poor synchronization with hardwares used in the system which can lead to delayed communication, thereby increasing the energy loss such as in the form of heat, sound, kinetic energy, and/or potential energy.

Typically, an application is developed to interact with system components either directly or via a middleware. In such systems, if complex functionalities are required, the application need to be extensive and can use significant amount of memory space of the system. Moreover, for using more than one type of platform, the application may need to be developed separately for each platform. Because of several applications, a complex architecture including several middleware is needed for monitoring or controlling the system.

Therefore, there is a need of a system which allows multiple functionalities using a single application or platform. Also, there is need of a system which can supply the energy to the loads using weather forecast data. Further, there is need for a system which can optimize the energy supply from energy source to the loads based on priority of using the energy sources. Furthermore, there is a need for a system which monitors the energy needed by the load. Yet, there is a need for a system which provides troubleshooting management.

### BRIEF DESCRIPTION OF THE DRAWINGS

Examples are described in the following detailed description and in reference to the drawings, in which:

FIG. 1 depicts an example system for optimizing energy supplied from energy sources to load devices, in accordance with an example of the techniques of the present application;

FIG. 2 depicts an example system with additional components for optimizing energy supplied from energy sources to load devices, in accordance with an embodiment of the techniques of the present application;

FIG. 3 depicts an example block diagram illustrating communication between components of the system with a weather channel for obtaining weather forecast data, in accordance with an example of the techniques of the present application;

FIG. 4 depicts an example method for optimizing energy supplied from energy sources to load devices, in accordance with an example of the techniques of the present application; and

FIG. 5 depicts an example block diagram showing a non-transitory, computer-readable medium that stores instructions for optimizing energy supplied from energy sources to load devices, in accordance with an example of the techniques of the present application.

### SUMMARY

It will be understood that this disclosure in not limited to the particular systems, and methodologies described, as there can be multiple possible embodiments of the present disclosure which are not expressly illustrated in the present subject matter. It is also to be understood that the terminology used in the description is for the purpose of describing the particular versions or embodiments of the present subject matter only, and is not intended to limit the scope of the present subject matter.

A hybrid system for optimizing energy supplied from energy sources to load device is described. The hybrid system determines power and energy needed by the load device. and optimize the energy generated by the energy sources for supplying to the a load device by selecting at least one energy source of the energy sources based on the received information and selection priority of the energy sources. In one example, the hybrid system may be connected to a weather forecast station to obtain weather forecast data for optimize the energy generated by the energy sources for supplying to the a load device. A battery storing energy from other sources is also considered as energy source.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated that the conception and specific embodiment disclosed may be readily utilized as a basis for modifying or designing other structures for carrying out the same purposes of the present disclosure. It should also be realized that such equivalent constructions do not depart from the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and the include plural references unless the context clearly dictates otherwise. Although any systems and methods similar or equivalent to those described herein can be used in the practice or testing of embodiments of the present disclosure, the preferred, systems and methods are now described.

The present application discloses a hybrid system for optimizing energy supplied from energy sources to load device is described. The hybrid system determines power and energy needed by the load device. and optimize the energy generated by the energy sources for supplying to the a load device by selecting at least one energy source of the energy sources based on the received information and selection priority of the energy sources. In one example, the hybrid system may be connected to a weather forecast station to obtain weather forecast data for optimize the energy generated by the energy sources for supplying to the a load device. The hybrid system manages energy and data to increase the performance and efficiency of components involved in energy generation, storage and distribution process. The hybrid system also synchronizes all components together to maximize their individual performance.

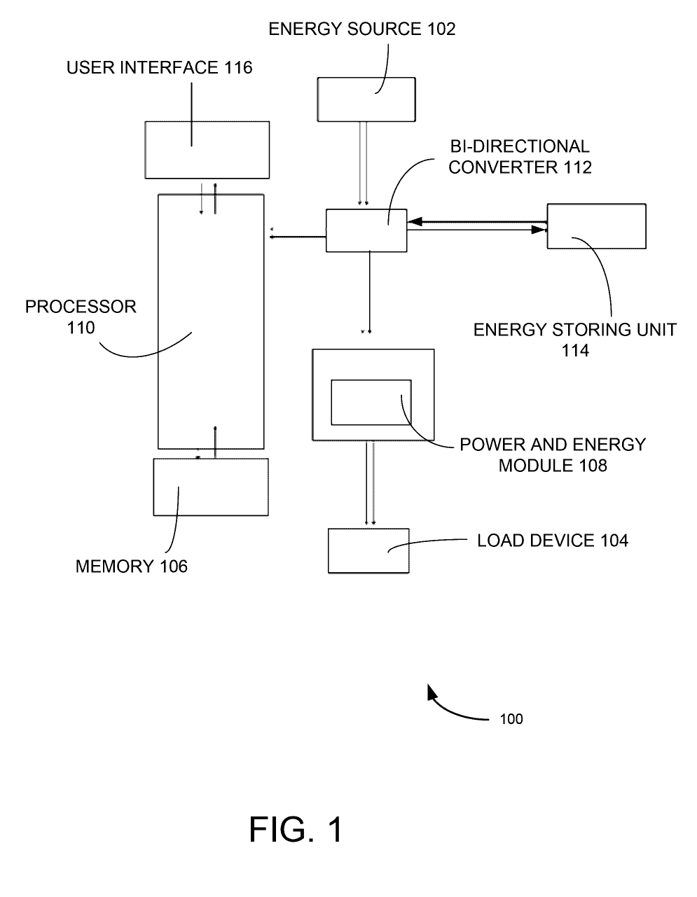

FIG. 1 illustrates an example system 100 for optimizing energy supplied from energy sources/energy generators 102 to load devices 104, in accordance with an embodiment of the present subject matter. Example energy sources may include solar energy, wind energy, hydro energy, hydrocarbon energy, hydrocarbon combustion energy, geothermal energy, fuel cell energy, hydrogen energy, water generated hydrogen energy, waste converted energy, solar thermal energy, natural gas energy, propane energy, electrochemical energy, tidal energy, and other renewable or non renewable energy sources.

The system 100 includes a memory/storage 106, a power and energy module 108 and a processor 110. The power and energy module 108 determines power and energy needed by the load device(s) 104. Further, the processor 110 is coupled to the memory 106 and executes instructions stored in the memory 106. The processor 110 receives information associated with the determined power and energy from the power and energy module 108. Using the received information and selection priority of the energy sources 102, the processor 110 optimizes the energy generated by the energy sources 102 for supplying to the load device 104. In one example, the energy generated may be optimized by selecting energy source 102 based on the received information and selection priority of the energy sources 102. Upon optimization, the processor 110 generates an alert based on data associated with the optimization and transmits the alert to one or more user devices and/or sent the alert to a user interface 116 for displaying.

Further, the hybrid system includes a bidirectional converter 112. The bidirectional converter 112 receives energy from the energy sources 102. The received energy may either be transmitted to the load device 104 via the power and energy module 108 and/or stored in an energy storing unit 114 prior to transmitting the energy to the load device 104. Further, the stored energy may be transmitted to the load device 104 in case there is no energy source 102 is available to supply the energy to the load devices 104. Also, the energy storing unit 114 transmits the stored energy to the load device 104 when the energy required by the load device 104 is greater than the energy generated by the energy sources 102. Example energy storing unit 114 includes lithium ion battery, sodium ion battery, manganese ion battery, aqueous ion battery, molten salt type battery, iron nickel battery, lithium air battery, lithium sulfur battery, primary non-rechargeable cell, fuel cell, nickel cadmium battery, nickel-metal hydride battery, nickel-zinc battery, zinc bromide battery, vanadium redox battery, sodium-sulfur battery, silver-oxide battery, quantum battery, capacitor, ultra-capacitor, li-ion capacitor, solar cell, solid state battery, flexible battery, zinc-air battery, zinc-carbon battery, aluminum-air battery, Bunsen battery, chromic acid battery, Daniell cell, dry cell, Edison-lalande cell, grove cell, leclanche cell, nickel oxyhydroxide cell, silicon air cell, Weston cell, zamboni cell, Li-polymer battery, and the like. Since the energy storing unit 114 may be of different types which may possess different charge and discharge characteristic, therefore processor 110 may use a defined set of protocols to charge a particular type of energy storing unit 114 for storing the generated energy. The memory 106 may store these set of protocols which is processed by the processor 110 to enable smooth charge/discharge process of the energy storing unit 114. Based on energy storing unit 114 chemistry or type of the energy storing unit 114, the processor 110 may activate controllers to use protocols, for example the protocol may be for providing constant current/constant voltage or floating current etc.

Furthermore, in a case if energy generated by the energy source 102 is greater than the energy needed by the load 104, the bidirectional converter 112 transmits some amount (amount needed by the load device) of generated energy to the load device 104 and remaining amount of generated energy is sent to the energy storing unit 114 for storing purpose which is utilized later. While transferring energy to the load device 104, the bidirectional converter 112 may convert either alternating current (AC) to direct current (DC) or DC to AC depending upon type of the load device 104. For example, if the energy source 102 is generating AC and load device 104 needs DC then the bidirectional converter 112 converts the generated AC into DC to meet the requirements of the load device 104. Similarly, if an AC load device 104 is connected and the energy is supplied from the energy storing unit 114, then the DC energy from the energy storing unit 114 is first converted into AC and then supplied to the AC load device 104.

For example, power level decision making requires a fast processing. For instance, if suddenly 20 washing machines are connected to the system 100 (Verses just one), energy need by these washing machines is increased. However, that energy must be supplied within fraction of seconds of switching on of the load device 104, and without any failure in supply or outage. Therefore, power and energy module 108 may take fast decisions for power and supply enough power as required by the load device 104.

On the otherhand, if washing machines are run, for example, for 20 hours continuously, the power and energy module 108 supply enough energy during this operation. If energy demand is more than the energy in the energy storing unit 114 (based on usage projection), the power and energy module 108 may send a signal to the processor 110 for informing the processor 110 about energy paucity and as a result a new energy source 102 may be activated by the processor 110 (based on history of usage) or by a user. The user can have predefined sequence for activating the energy sources 102. If the energy to be supplied is insufficient from one source, then the processor 110 may activate the next energy source in sequence and so on.

Further, the power and energy module may include a memory (e.g., cache memory), a controller (not shown in figures) coupled to the memory, and sensors. Example sensors may include a current sensor, a voltage sensor, and a resistance sensor. The current sensor may sense the current flowing through terminals of the load device 104. The voltage sensor may sense the voltage across the load device 104. Similarly, the resistance sensor may sense the resistance to the flow of the current through the load device 104. These currents, voltage, and resistance sensed by the sensors may be used to determine power and energy needed by the load device 104. Once the power and energy needed by the load device 104 is determined, the information associated with the determined power and energy is transmitted by the controller to the processor 110. Example controller may include a current, voltage and resistance controllers for filtering and controlling current and voltage passing through the current, voltage and resistance controllers.

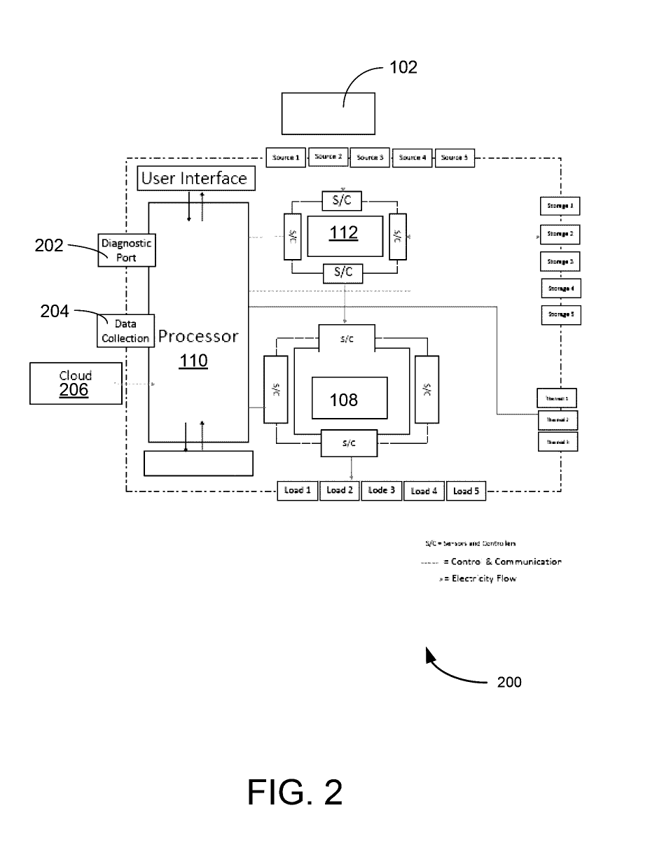

FIG. 2 illustrates an example system 200 with additional components for optimizing energy supplied from energy sources to load devices, in accordance with an embodiment of the subject matter. The additional component may be a diagnostic port 202, data collection unit 204, and a cloud 206. The diagnostic port 202 may be utilized for troubleshooting problems or for monitoring the system 200. Further, the processor 110 is communicatively connected to the cloud 206 for sending information associated with optimization of the power and the energy for supplying to the load device 104. Also, all data collected within the system 200 is cloned in the cloud storage in real time and any activity on the system 200 can be monitored/controlled/recorded remotely. All activities of the system 200 can be controlled via Internet where security layers, encryption and private network are some of the example features used for data transmission. Further, the data collection unit 204 may collect data from the memory 106 which can be copied for analysis on different systems, backup and keeping record.

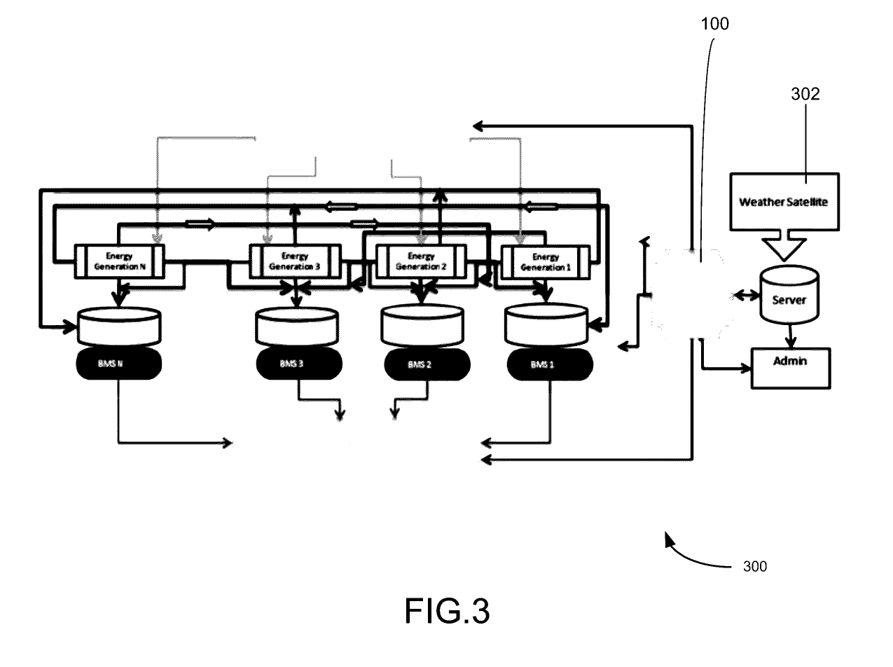

FIG. 3 illustrates an example block diagram 300 illustrating communication between components of the system with a weather channel/weather satellite 302 for obtaining weather forecast data, in accordance with an example of the present subject matter. The processor 110 is communicatively connected to the weather channel 302 for obtaining weather forecast data of a geographical location for optimizing the energy generated by the energy sources 102 for supplying to the load devices 104 based on the weather forecast data.

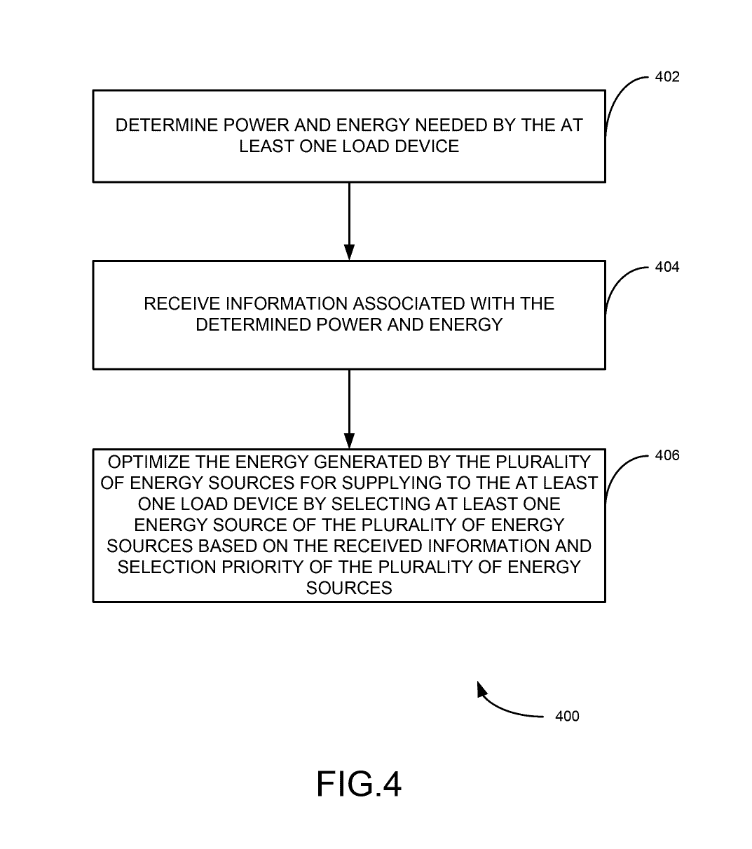

FIG. 4 depicts an example flow chart 400 of a process for optimizing energy supplied from energy sources to load devices, in accordance with an example of the techniques of the present application.

It should be understood the process depicted in FIG. 4 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, Application Specific Integrated Circuits (ASICs), or other hardware components associated with the system. Furthermore, the flow charts are not intended to limit the implementation of the present application, but rather the flow charts illustrate functional information to design/fabricate circuits, generate software, or use a combination of hardware and software to perform the illustrated processes.

The process 400 may begin at block 402, where power and energy needed by the load device is determined by the power and energy module. The power and energy module may include several controllers and sensors. The sensors may sense voltage across the load and current flowing through them to determine the power required by the load. Similarly, number of hours of use of the load is determined to calculate the energy requirement by the load. The power and energy module may also include cache memory for storing data during the processing. Processing proceeds to block 404.

At block 404, information associated with the determined power and energy is received by a processor. Processing proceeds to block 406.

At block 406, the energy generated by the plurality of energy sources for supplying to the at least one load device is optimized by the processor. For example, the energy generated is optimized by selecting at least one energy source based on the received information and selection priority of the energy sources.

The process 400 of FIG. 4 shows an example process and it should be understood that other configurations can be employed to practice the techniques of the present application. For example, process 400 may be configured to communicate with a plurality of computing devices and the like.

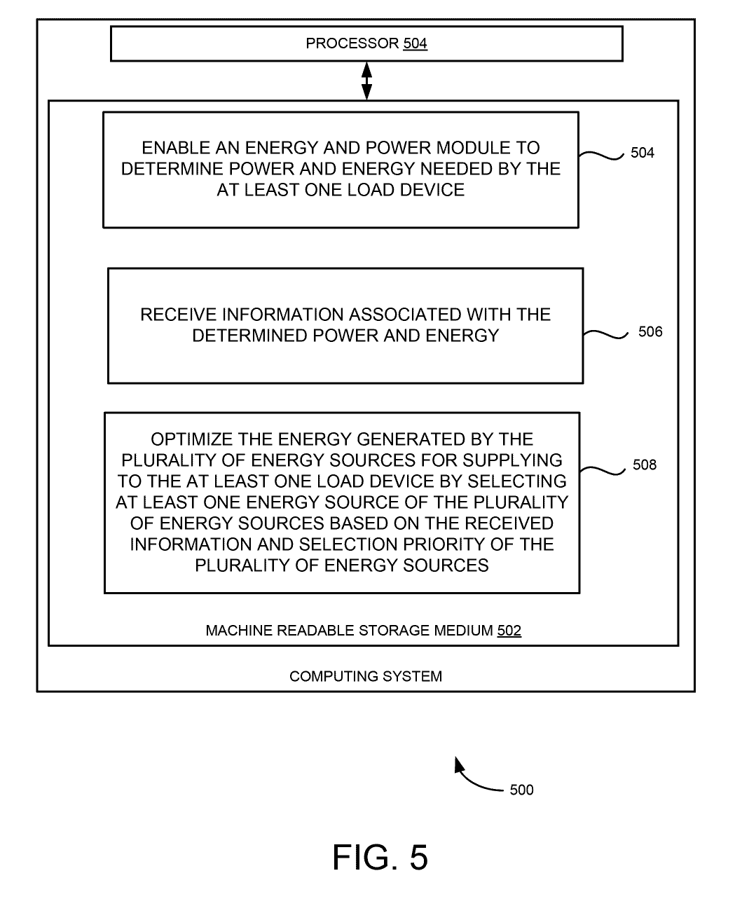

FIG. 5 is an example block diagram showing a non-transitory, computer-readable medium that stores code for operation in accordance with an example of the techniques of the present application. The non-transitory, computer-readable medium is generally referred to by the reference number 500 and may be included in the system in relation to FIG. 1. The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

A processor 502 generally retrieves and executes the instructions stored in the non-transitory, computer-readable medium 500 to operate the present techniques in accordance with an example. In one example, the tangible, computer-readable medium 500 can be accessed by the processor 502 over a bus. A region of the non-transitory, computer-readable medium 500 may include a power and energy module 108 functionality as described herein. The power and energy module 108 functionality may be implemented in hardware, software or a combination thereof.

For example, block 504 provides instructions which may include instructions to enable an energy and power module to determine power and energy needed by the at least one load device, as described herein.

For example, block 506 provides instructions which may include instructions to receive information associated with the determined power and energy, as described herein.

For example, block 506 provides instructions which may include instructions to optimize the energy generated by the energy sources for supplying to the load device. For example, the energy generated may be supplied to the load device by selecting at least one energy source based on the received information and priority of the energy sources.

Although shown as contiguous blocks, the software components can be stored in any order or configuration. For example, if the non-transitory, computer-readable medium 500 is a hard drive, the software components can be stored in non-contiguous, or even overlapping, sectors.

As used herein, a “processor” may include processor resources such as at least one of a Central Processing Unit (CPU), a semiconductor-based microprocessor, a Graphics Processing Unit (GPU), a Field-Programmable Gate Array (FPGA) configured to retrieve and execute instructions, other electronic circuitry suitable for the retrieval and execution instructions stored on a computer-readable medium, or a combination thereof. The processor fetches, decodes, and executes instructions stored on medium 500 to perform the functionalities described below. In other examples, the functionalities of any of the instructions of medium 500 may be implemented in the form of electronic circuitry, in the form of executable instructions encoded on a computer-readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable medium described herein may be non-transitory. In examples described herein, a computer-readable medium or media is part of an article (or article of manufacture). An article or article of manufacture may refer to any manufactured single component or multiple components. The medium may be located either in the system executing the computer-readable instructions, or remote from but accessible to the system (e.g., via a computer network) for execution. In the example of FIG. 5, medium 500 may be implemented by one computer-readable medium, or multiple computer-readable media.

In examples described herein, computing device may communicate with components implemented on separate devices or system(s) via a network interface device of the computing device. For example, computing device may communicate with storage device via a network interface device of the computing device. In another example, computing device may communicate with target computing devices via a network interface device of the computing device. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, or the like, or a combination thereof. In some examples, a computer network may include a telephone network (e.g., a cellular telephone network).

In some examples, instructions 504-508 may be part of an installation package that, when installed, may be executed by processor 502 to implement the functionalities described herein in relation to instructions 504-508. In such examples, medium 500 may be a portable medium, such as a CD, DVD, or flash drive, or a memory maintained by a server from which the installation package can be downloaded and installed. In other examples, instructions 504-508 may be part of an application, applications, or component(s) already installed on computing device including processor 502. In such examples, the medium 500 may include memory such as a hard drive, solid state drive, or the like. In some examples, functionalities described herein in relation to FIGS. 1 through 5 may be provided in combination with functionalities described herein in relation to any of FIGS. 1 through 5.

It will finally be understood that the disclosed embodiments are presently preferred examples of how to make and use the claimed disclosure, and are intended to be explanatory rather than limiting of the scope of the disclosure as defined by the claims below. Reasonable variations and modifications of the illustrated examples in the foregoing written specification and drawings are possible without departing from the scope of the disclosure as defined in the claim below. It should further be understood that to the extent the term “disclosure” is used in the written specification, it is not to be construed as a limited term as to number of claimed or disclosed disclosures or the scope of any such disclosure, but as a term which has long been conveniently and widely used to describe new and useful improvements in technology The scope of the disclosure supported by the above disclosure should accordingly be construed within the scope of what it teaches and suggests to those skilled in the art, and within the scope of any claims that the above disclosure supports. The scope of the disclosure is accordingly defined by the following claims.

What is claimed is:

1. A hybrid system for optimizing energy supplied from a plurality of energy sources to at least one load device, comprising:
a memory;
a power and energy module to determine power and energy needed by the at least one load device;
a processor coupled to the memory and executes instructions stored in the memory, the processor to:
receive information associated with the determined power and energy from the power and energy module; and
optimize the energy generated by the plurality of energy sources for supplying to the at least one load device by selecting at least one energy source of the plurality of energy sources based on the received information and selection priority of the plurality of energy sources.

2. The hybrid system of claim 1, further comprising a bidirectional converter to:
receive energy from the plurality of energy sources to perform one of:
transmitting the received energy to the at least one load device via the power and energy module; and
storing the received energy in an energy storing unit prior to transmitting the energy to the at least one load device;

3. The hybrid system of claim 2, wherein the energy storing unit transmits the stored energy to the at least one load device when the energy required by the at least one load device is greater than the energy generated by the plurality of energy sources.

4. The hybrid system of claim 2, wherein the energy storing unit transmits the stored energy to the at least one load device in absence of the plurality of energy sources.

5. The hybrid system of claim 2, wherein the energy storing unit is selected from the group consisting of lithium ion battery, sodium ion battery, manganese ion battery, aqueous ion battery, molten salt type battery, iron nickel battery, lithium air battery, lithium sulfur battery, primary non-rechargeable cell, fuel cell, nickel cadmium battery, nickel-metal hydride battery, nickel-zinc battery, zinc bromide battery, vanadium redox battery, sodium-sulfur battery, silver-oxide battery, quantum battery, capacitor, ultra-capacitor, Li-ion capacitor, solar cell, solid state battery, flexible battery, zinc-air battery, zinc-carbon battery, aluminum-air battery, Bunsen battery, chromic acid battery, Daniell cell, dry cell, Edison-lalande cell, grove cell, leclanche cell, nickel oxyhydroxide cell, silicon air cell, Weston cell, zamboni cell, and Li-polymer battery.

6. The hybrid system of claim 2, wherein the energy received by the bidirectional converter is transmitted to the at least one load device when the energy required by the at least one load device is less than the received energy.

7. The hybrid system of claim 1, wherein the plurality of energy sources is selected from the group consisting of solar energy, wind energy, hydro energy, hydrocarbon energy, hydrocarbon combustion energy, geothermal energy, fuel cell energy, hydrogen energy, water generated hydrogen energy, waste converted energy, solar thermal energy, natural gas energy, propane energy, electrochemical energy, and tidal energy.

8. The hybrid system of claim 2, wherein the bidirectional converter converts one of alternating current (AC) to direct current (DC) and DC to AC depending upon type of the at least one load.

9. The hybrid system of claim 1, wherein the processor generates an alert based on data associated with the optimization.

10. The hybrid system of claim 9, wherein the processor transmits the alert to one or more user devices.

11. The hybrid system of claim 1, wherein the power and energy module comprises a memory, a controller coupled to the memory, and sensors, wherein the controller is communicatively connected to the processor for transmitting the information associated with the determined power and energy.

12. The hybrid system of claim 11, wherein the sensors comprises a current sensor, a voltage sensor, and a resistance sensor .

13. The hybrid system of claim 11, wherein the controller comprises a current, voltage and resistance controllers for filtering and controlling current and voltage passing through the current, voltage and resistance controllers.

14. The hybrid system of claim 1, further comprising a diagnostic port for troubleshooting problems.

15. The hybrid system of claim 1, wherein the processor is communicatively connected to a cloud for sending information associated with optimization of the power and the energy for supplying to the at least one load device.

16. The hybrid system of claim 1, wherein the processor is communicatively connected to a weather channel for obtaining weather forecast data of a geographical location for optimizing the energy generated by the plurality of energy sources for supplying to the at least one load device based on the weather forecast data.

17. A method for optimizing energy supplied from a plurality of energy sources to at least one load device, comprising:
determining power and energy needed by the at least one load device;
Receiving, by a processor, information associated with the determined power and energy; and
Optimizing, by the processor, the energy generated by the plurality of energy sources for supplying to the at least one load device by selecting at least one energy source of the plurality of energy sources based on the received information and selection priority of the plurality of energy sources.

18. The method of claim 17, further comprising:
receiving, by a bidirectional converter, energy from the plurality of energy sources to perform one of:
transmitting the received energy to the at least one load device; and
storing the received energy in an energy storing unit prior to transmitting the energy to the at least one load device.

19. The method of claim 18, further comprising:
transmitting the stored energy to the at least one load device from the energy storing unit when the energy required by the at least one load device is greater than the energy generated by the plurality of energy sources.

20. The method of claim 18, further comprising:
transmitting the energy received by the bidirectional converter to the at least one load device when the energy required by the at least one load device is less than the received energy.

21. The method of claim 17, further comprising:
generating an alert by the processor based on data associated with the optimization.

22. The method of claim 21, further comprising:
transmitting, by the processor, the alert to one or more user devices.

23. The method of claim 17, further comprising sending information associated with optimization of the power and the energy for supplying to the at least one load device to a cloud.

24. A non-transitory computer-readable medium having computer executable instructions stored thereon for optimizing energy supplied from energy sources to load devices, the instructions are executable by a processor to:
enable an energy and power module to determine power and energy needed by the at least one load device;
receive information associated with the determined power and energy; and
optimize the energy generated by the plurality of energy sources for supplying to the at least one load device by selecting at least one energy source of the plurality of energy sources based on the received information and selection priority of the plurality of energy sources.
